(19) United States
(12) Patent Application Publication
(10) Pub. No.: US 2026/0186795 A1
(43) Pub. Date: Jul. 2, 2026

(54) GRAPHICAL USER INTERFACE FOR AN EVENT-SOURCED SYSTEM

(71) Applicant: UVeye Ltd., Tel Aviv (IL)

(72) Inventor: Idan COHEN, Tel Aviv (IL)

(73) Assignee: UVeye Ltd., Tel Aviv (IL)

(21) Appl. No.: 19/004,348

(22) Filed: Dec. 29, 2024

(51) Int. Cl. G06F 9/451; G06F 9/455; G06F 9/54

(52) U.S. Cl. CPC G06F 9/451; G06F 9/45504; G06F 9/542

(57) ABSTRACT

There is provided a method of processing data using a processor coupled to a memory, the method comprising: display via a display device of a client computing device, an interactive graphical user interface (GUI) for monitoring and managing an event-sourced system, presenting within the GUI: messages transmitted within the event-sourced system, events of the event-sourced system, and commands executed by the event-sourced system, receiving, via the GUI, a selection for emulation of execution of a message and/or a, in response to the selection for emulation, computing an emulation of execution of the selected message and/or command, within the event-sourced system, and dynamically updating messages, the events, and/or the commands, presented within the GUI, with an outcome of the emulation of execution of the selected message and/or command, within the event-sourced system.

### BACKGROUND

The present invention, in some embodiments thereof, relates to a graphical user interface (GUI) and, more specifically, but not exclusively, to a GUI for managing an event-sourced system.

An event-sourced system is a type of software architecture where the state of the system is determined by a sequence of events, rather than by storing the current state directly. In this approach, all changes to the application's state are stored as a series of events, and the current state is derived by replaying these events in sequence.

### SUMMARY

According to a first aspect, a computer implemented method of processing data using at least one processor coupled to a memory, the method comprises: displaying via a display device of a client computing device, an interactive graphical user interface (GUI) for monitoring and managing an event-sourced system, presenting within the GUI: a plurality of messages transmitted within the event-sourced system, a plurality of events of the event-sourced system, and a plurality of commands executed by the event-sourced system, receiving, via the GUI, a selection for emulation of execution of at least one of: a message from the plurality of messages, and a command from the plurality of commands, in response to the selection for emulation, computing an emulation of execution of the selected at least one of: the message and the command, within the event-sourced system, and dynamically updating at least one of the plurality of messages, the plurality of events, and the plurality of commands, presented within the GUI, with an outcome of the emulation of execution of the selected at least one of: the message and the command, within the event-sourced system.

According to a second aspect, a system for processing data using at least one processor coupled to a memory, comprising: at least one processor executing a code for: displaying via a display device of a client computing device, an interactive graphical user interface (GUI) for monitoring and managing an event-sourced system, presenting within the GUI: a plurality of messages transmitted within the event-sourced system, a plurality of events of the event-sourced system, and a plurality of commands executed by the event-sourced system, receiving, via the GUI, a selection for emulation of execution of at least one of: a message from the plurality of messages, and a command from the plurality of commands, in response to the selection for emulation, computing an emulation of execution of the selected at least one of: the message and the command, within the event-sourced system, and dynamically updating at least one of the plurality of messages, the plurality of events, and the plurality of commands, presented within the GUI, with an outcome of the emulation of execution of the selected at least one of: the message and the command, within the event-sourced system.

According to a third aspect, a non-transitory medium storing program instructions for processing data using at least one processor coupled to a memory, comprises program instructions which when executed by the at least one processor, cause the at least one processor to: display via a display device of a client computing device, an interactive graphical user interface (GUI) for monitoring and managing an event-sourced system, present within the GUI: a plurality of messages transmitted within the event-sourced system, a plurality of events of the event-sourced system, and a plurality of commands executed by the event-sourced system, receive, via the GUI, a selection for emulation of execution of at least one of: a message from the plurality of messages, and a command from the plurality of commands, in response to the selection for emulation, compute an emulation of execution of the selected at least one of: the message and the command, within the event-sourced system, and dynamically update at least one of the plurality of messages, the plurality of events, and the plurality of commands, presented within the GUI, with an outcome of the emulation of execution of the selected at least one of: the message and the command, within the event-sourced system.

In a further implementation form of the first, second, and third aspects, the emulation of execution of the selection is for re-running of a previously generated message and/or re-execution of a previously executed command, starting from a preceding snapshot of the event-sourced system prior to generation of the message and/or prior to execution of the command.

In a further implementation form of the first, second, and third aspects, the emulation of execution of the selection is for a prediction of impact on the event-sourced system by generation of a new message and/or execution of a new command.

In a further implementation form of the first, second, and third aspects, further comprising toggling the GUI between a first state depicting the messages, events, and commands in response to the emulation, and a second state depicting the messages, events, and commands prior to the emulation.

In a further implementation form of the first, second, and third aspects, the emulation is performed by importing the events to another computing environment separate from the event-sourced system where conditions of the event-sourced system are replicated, and executing the selected at least one of: the message and the command, within the another computing environment without impacting the event-sourced system.

In a further implementation form of the first, second, and third aspects, further comprising: wherein in response to a failure and/or error in the event-sourced system generated during the emulation of execution, presenting within the GUI, the message and/or the command that triggered the failure and/or error.

In a further implementation form of the first, second, and third aspects, at least one of: a new message, a new event, and a new command, is generated in response to the emulated execution, wherein at least one of the plurality of messages, the plurality of events, and the plurality of commands, presented within the GUI, are updated to include the at least one of: the new message, the new event, and the new command.

In a further implementation form of the first, second, and third aspects, at least one of: an existing message, an existing event, and an existing command, is adapted in response to the emulated execution, wherein at least one of the plurality of messages, the plurality of events, and the plurality of commands, presented within the GUI, are updated to depict the at least one of: the adapted message, the adapted event, and the adapted command.

In a further implementation form of the first, second, and third aspects, further comprising visually marking within the GUI at least one of the plurality of messages, the plurality of events, and the plurality of commands, predicted to be impacted by the emulation.

In a further implementation form of the first, second, and third aspects, further comprising: predicting a full state of the event-sourced system in response to the emulation, and wherein dynamically updating comprises presenting the prediction of the full state within the GUI.

In a further implementation form of the first, second, and third aspects, further comprising: predicting at least one data projection in response to the emulation, wherein the at least one data projection is computed based on a prediction of the plurality of events in response to the emulation, and wherein dynamically updating comprises presenting the prediction of the at least one data projection within the GUI.

In a further implementation form of the first, second, and third aspects, further comprising: computing at least one predicted snapshot indicating a predicted state of at least one component of the event-sourced system, in response to the emulation, and wherein dynamically updating comprises presenting the at least one predicted snapshot within the GUI.

In a further implementation form of the first, second, and third aspects, the selection for emulation comprises a message selected from the plurality of messages presented within the GUI, and emulation comprises emulating re-sending of the message to the event-sourced system.

In a further implementation form of the first, second, and third aspects, the selection for emulation comprises a command selected from the plurality of commands presented within the GUI, and emulation comprises emulating repeating execution of the command within the event-sourced system.

In a further implementation form of the first, second, and third aspects, the selection for emulation comprises at least one of: a new message and a new command manually entered by a user and/or selected via the GUI from a predefined list, and emulation comprises predicting impact of at least one of: sending the at least one new message to the event-sourced system and execution of the new command by the event-sourced system.

In a further implementation form of the first, second, and third aspects, further comprising: receiving a selection of at least one of: a message from the plurality of messages, and a command from the plurality of commands, and presenting within the GUI, a hierarchy of the at least one of: the selected message, and the selected command, the hierarchy including ancestors and descendants.

In a further implementation form of the first, second, and third aspects, the at least one of selected message and the selected command comprises the message and/or command selected for emulation, and wherein the hierarchy of the at least one of the selected message and the selected command includes a predicted hierarchy including predicted ancestors and descendants, generated in response to the emulation.

In a further implementation form of the first, second, and third aspects, at least one of the selected message and the selected command comprises at least one of a new message and a new command predicted to be generated in response to the emulation, wherein the GUI presents the hierarchy for at least one of the predicted new message and the predicted new command.

In a further implementation form of the first, second, and third aspects, further comprising: receiving, via the GUI, a selection of an event of the plurality of events, predicting the full state according to the selected event, and presenting the predicted full state within the GUI.

In a further implementation form of the first, second, and third aspects, the selected event comprises a new event predicted to occur in response to the emulation.

In a further implementation form of the first, second, and third aspects, further comprising: computing a total number of at least one of: reads, runtime, and size, of the plurality of events, and presenting within the GUI, the total number of the at least one of: reads, runtime, and size.

In a further implementation form of the first, second, and third aspects, the total number of at least one of: reads, runtime, and size, is computed for the updated plurality of events predicted in response to emulation.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for generating and/or operating a GUI for monitoring and/or managing and/or analyzing an event-sourced system, in accordance with some embodiments of the present invention;

FIG. 2 is a flowchart of a method of generating and/or operating a GUI for monitoring and/or managing and/or analyzing an event-sourced system, in accordance with some embodiments of the present invention;

FIG. 3 is a schematic of an exemplary GUI for monitoring and/or managing and/or analyzing an event-sourced system, in accordance with some embodiments of the present invention;

FIG. 4 is a schematic of the exemplary GUI, depicting additional features for monitoring and/or managing and/or analyzing an event-sourced system, in accordance with some embodiments of the present invention;

FIG. 5 is a schematic of an exemplary GUI depicting an interactive element for reducing the state to a specific event, in accordance with some embodiments of the present invention; and

FIG. 6 is an exemplary GUI depicting a window presenting a hierarchy for a selected message, in accordance with some embodiments of the present invention.

### DETAILED DESCRIPTION

The present invention, in some embodiments thereof, relates to a graphical user interface (GUI) and, more specifically, but not exclusively, to a GUI for managing an event-sourced system.

The terms GUI and interactive dashboard interface may be interchangeable.

An aspect of some embodiments of the present invention relates to systems, methods, computing device, and/or code instructions (stored on a data storage device) for generating and/or operating an interactive GUI for monitoring and/or managing an event-sourced system. One or more of the following are presented within the GUI, optionally within respective windows, optionally arranged as columns: messages transmitted within the event-sourced system, events of the event-sourced system, and commands executed by the event-sourced system. A selection for emulation of execution is received via the GUI. The selection for emulation of execution may include a message which may be selected from the messages presented within the GUI, and/or a command which may be selected from the commands presented within the GUI. An emulation of execution of the selected the message and/or the command within the event-sourced system is computed. The emulation may be for re-running of a previously generated messages and/or re-execution of a previously executed command, optionally from a snapshot of the event-sourced system prior to generation of the messages and/or execution of the command. Alternatively, the emulation may be for predicting impact on the event-sourced system by generation of the selected message representing a new message and/or by execution of the selected command represented a new command. The GUI is dynamically updated to depict the outcome of emulation of execution of the selected message and/or command within the event-sourced system. The messages, events, and/or commands within the GUI are dynamically updated to represent the state of the event-sourced system in response to the emulation. The GUI may be dynamically updated to depict the messages, events, and/or commands prior to the emulation, for example, after a user has inspected the GUI depicting the emulation. The user may toggle between the GUI depicting the messages, and/or events and/or commands prior to emulation and post emulation.

At least one embodiment described herein addresses the technical problem of monitoring and/or analyzing and/or managing an event-sourced system. At least one embodiment described herein improves the technology of GUIs, by providing a GUI designed for monitoring and/or analyzing and/or managing an event-sourced system. At least one embodiment described herein improves upon existing approaches of monitoring and/or analyzing and/or managing an event-sourced system. At least one embodiment described herein provides the practical application of improving the user experience of monitoring and/or analyzing and/or managing an event-sourced system, by the GUI described herein.

Monitoring and/or analyzing and/or managing an event-sourced system is technically challenging. Event-sourced systems accumulate events continuously, leading to massive data volumes over time, making it difficult for a user to effectively monitor and/or analyze and/or manage the event-sourced system. Event-sourced systems provide powerful capabilities for tracking history and auditing but come with significant challenges in monitoring, analyzing, and managing due to the volume of events, immutability, consistency issues, and operational complexity. Traditional monitoring tools may not offer direct insights into event streams, such as the number of unprocessed events or event processing times. Tracking the lifecycle of events as they propagate through multiple services can be challenging. Identifying what to monitor (such as queue length, event processing time, or event lag) and setting actionable alert thresholds can be challenging. Too many alerts create noise, while too few risk missing issues. Performing real-time or near-real-time analytics on a constantly updating event stream is complex. Event-sourced systems may allow for temporal analysis, but deriving meaningful insights from the sequence of events over time can be non-trivial. Understanding cause-and-effect relationships between events and tracking dependencies between them can be analytically complex.

Standard approaches to monitor and/or analyze and/or manage an event-sourced system are based on using multiple specific tools, where each tool is designed for a specific task. A user may be required to use multiple different tools to analyze different aspects of the event-sourced system, for example, in order to detect the source of an error.

Exemplary potential advantage of some embodiments:
The GUI interface provides real-time visualization and tracking of produced (e.g., uploaded) messages, events, and executed commands, of the event-sourced system.
The GUI may include features for capturing full system states and/or snapshots, and optionally multiple data projections, facilitating comprehensive state management and/or historical analysis and/or other types of analysis.
The GUI is designed to enhance the user experience by facilitating easy navigation and interpretation of complex data.
The multiple data projections presented by the GUI enable users to view and analyze event data from various perspectives, which may enhance interpretability and decision-making.
The GUI is designed to provide easy navigation and/or clear visual representations of complex system interactions.
The GUI is designed to provide a centralized view to monitor system activities, capture states, and analyze data projections.
The design emphasizes usability, real-time data updates, and clear visual representations of complex system interactions.

At least one embodiment described herein provides a solution to the aforementioned technical problem, and/or improves upon the aforementioned technical field, and/or improves upon the aforementioned existing approaches, and/or provides the practical application of a GUI that is dynamically updated to depict the outcome of emulation of execution of the selected message and/or command within the event-sourced system. The messages, events, and/or commands within the GUI are dynamically updated to represent the state of the event-sourced system in response to the emulation. The dynamically updated GUI may represent a predicted state of the event-sourced system in response to the emulation, or a “replay” of the state of the event-sourced system in response to the emulation. The dynamically updated GUI may be used, for example, to trouble shoot errors in the event-sourced system, for example, by toggling the GUI between a first state depicting the messages, events, and commands in response to the emulation, and a second state depicting the messages, events, and commands prior to the emulation, which may be used by a user to help understand the impact of the emulation as part of a troubleshooting process.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

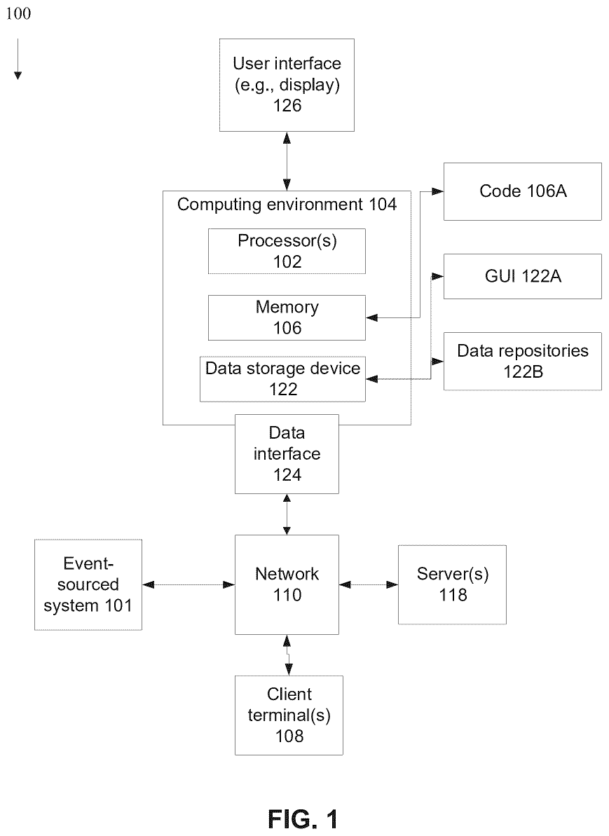

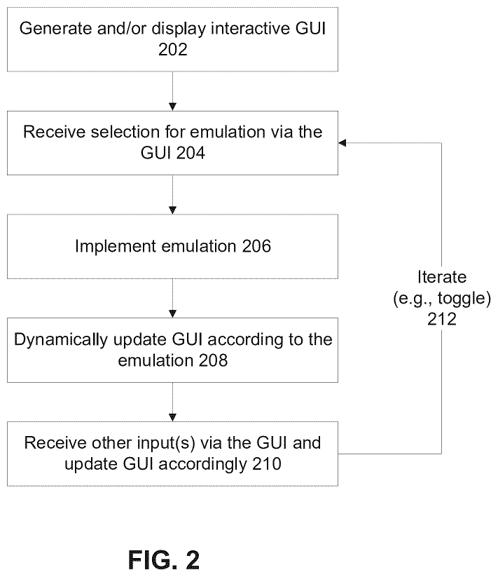

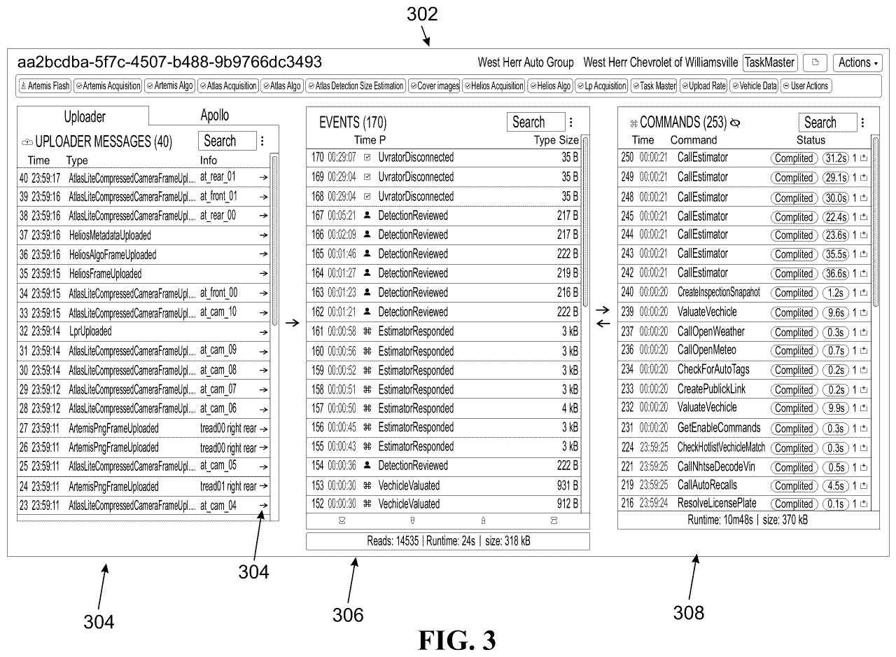

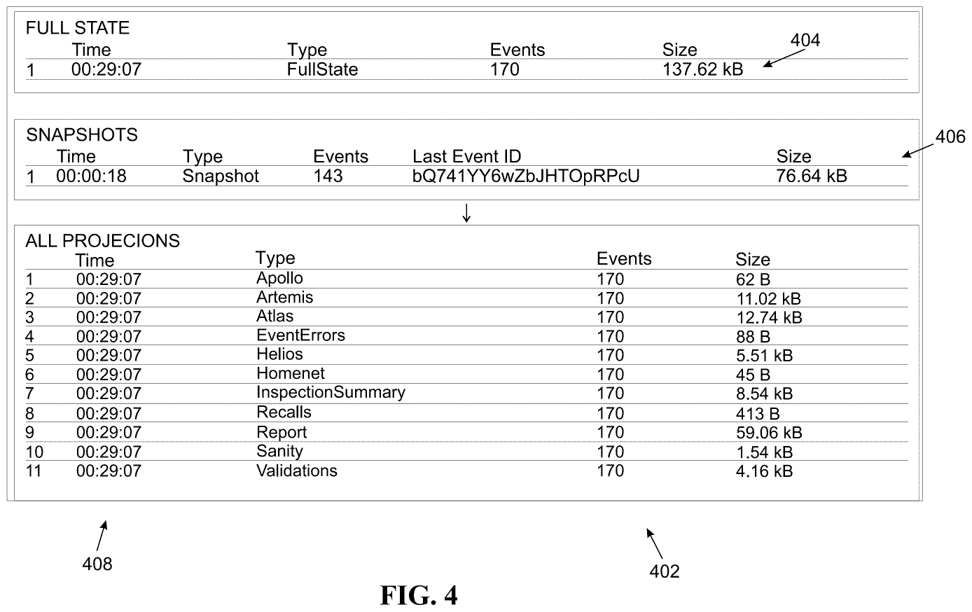

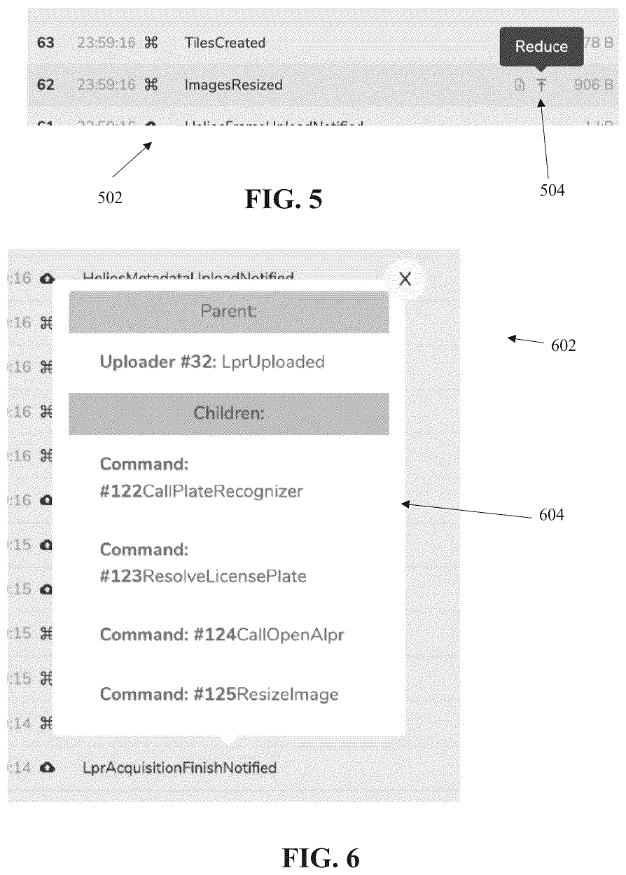

Reference is made to FIG. 1, which is a block diagram of components of a system 100 for generating and/or operating a GUI 122A for monitoring and/or managing and/or analyzing an event-sourced system 101, in accordance with some embodiments of the present invention. Reference is also made to FIG. 2, which is a flowchart of a method of generating and/or operating a GUI for monitoring and/or managing and/or analyzing an event-sourced system, in accordance with some embodiments of the present invention. Reference is also made to FIG. 3, which is a schematic of an exemplary GUI for monitoring and/or managing and/or analyzing an event-sourced system, in accordance with some embodiments of the present invention. Reference is also made to FIG. 4, which is a schematic of the exemplary GUI, depicting additional features for monitoring and/or managing and/or analyzing an event-sourced system, in accordance with some embodiments of the present invention. Reference is also made to FIG. 5, which is a schematic of an exemplary GUI 502 depicting an interactive element for reducing the state to a specific event, in accordance with some embodiments of the present invention. Reference is also made to FIG. 6, which is an exemplary GUI 602 depicting a window 604 presenting a hierarchy for a selected message, in accordance with some embodiments of the present invention.

System 100 may execute the acts of the method described with reference to FIG. 2, for example, by a processor(s) 102 of a computing device 104 executing code 106A stored in a memory 106.

Computing device 104 monitors messages, events, and/or commands of an event-sourced system 101, and dynamically updates a GUI 122A, which may be accessed by a client terminal 108

Computing environment 104 may be implemented as, for example, a client terminal, a virtual machine, a server, a virtual server, a computing cloud, a group of connected devices, a mobile device, a desktop computer, a thin client, a kiosk, and a mobile device (e.g., a Smartphone, a Tablet computer, a laptop computer, a wearable computer, glasses computer, and a watch computer).

Multiple architectures of system 100 based on computing environment 104 may be implemented. For example:
Computing environment 104 executing stored code instructions 106A, may be implemented as one or more servers (e.g., network server, web server, a computing cloud, a virtual server) that provides services (e.g., one or more of the acts described with reference to FIG. 2 to one or more client terminals 108 over a network 110. For example, providing software as a service (SaaS) to the client terminal(s) 108, providing software services accessible using a software interface (e.g., application programming interface (API), software development kit (SDK)), providing an application for local download to the client terminal(s) 108, providing an add-on to a web browser running on client terminal(s) 108, and/or providing functions using a remote access session to the client terminals 108, such as through a web browser executed by client terminal 108 accessing a web sited hosted by computing environment 108. For example, client terminals access GUI 122A running on computing environment 104 via web browsers running on the client terminals, client terminals download GUI 122A for local execution (e.g., an app running on a smartphone), a plug-in that runs and/or accesses GUI 122BA is installed on the web browser running on the client terminals, and/or client terminals use an API to access GUI 122A running on computing environment 104. In such implementation, users using client terminals 108 to monitor and/or analyze event-sourced system 101 via centralized GUI 122A running on computing environment 104, as described herein.
Computing environment 104 may be implemented as a standalone device (e.g., kiosk, client terminal, smartphone, server) that includes locally stored code instructions 106A and/or GUI 122A that implement one or more of the acts described with reference to FIG. 2. The locally stored instructions may be obtained from another server (e.g., 118), for example, by downloading the code over the network, and/or loading the code from a portable storage device. In such implementation, each user uses their own computing environment 104 to locally monitor and/or analyze event-sourced system 101 via local GUI 122A running on computing environment 104, as described herein.

Hardware processor(s) 102 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include one or more processors (homogenous or heterogeneous), which may be arranged for parallel processing, as clusters and/or as one or more multi core processing units.

Memory 106 (also referred to herein as a program store, and/or data storage device) stores code instruction for execution by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more acts and/or features of the method described with reference to FIG. 2.

Computing environment 104 may include a data storage device 122 for storing data, for example, GUI code 122B for monitoring and/or analyzing event-sourced system 101, and one or more data repositories 122B for storing different data as described herein. Data storage device 122 may be implemented as, for example, a memory, a local hard-drive, a removable storage device, an optical disk, a storage device, and/or as a remote server and/or computing cloud (e.g., accessed over network 110). It is noted that code 122A-B may be stored in data storage device 122, with executing portions loaded into memory 106 for execution by processor(s) 102.

Computing environment 104 may monitor event-sourced system 101, for example, via monitoring code, code sensors, a data sniffer, a data interceptor, and the like. Computing environment 104 may monitoring event-sourced system 101, via for example, a wire connection (e.g., physical port), a wireless connection (e.g., antenna), a local bus, a port for connection of a data storage device, a network interface card, other physical interface implementations, and/or virtual interfaces (e.g., software interface, virtual private network (VPN) connection, application programming interface (API), and software development kit (SDK)).

Computing environment 104 may include data interface 124, optionally a network interface, for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing environment 104 and/or client terminal(s) 108 includes or is in communication with a physical user interface 126 that includes a mechanism designed for a user to interact with GUI presented on a display by executing GUI 122A. Exemplary physical user interfaces 126 include, for example, one or more of, a touchscreen, a display, a keyboard, a mouse, and voice activated software using speakers and microphone.

Referring now back to FIG. 2, at 202, the interactive GUI for monitoring and/or managing and/or analyzing an event-sourced system is generated and/or presented on a display.

GUI may present may present one or more of the following datasets: messages transmitted within the event-sourced system, events of the event-source system, and commands executed by the event-sourced system.

A message may be a packet of data exchanged between components of the event-sourced system. Messages may propagate changes, trigger actions, or notify other components of state changes. The message may represent an event and/or command, where events and/or commands presented within the GUI may be related to a message presented within the GUI.

An event may indicate a significant change in the state of the event-sourced system. The event captures something that has already happened. Events may represent the core data entities in event-sourcing architectures. Events may serve as the authoritative history of all state changes in the event-sourced system.

Commands may be instructions to the event-sourced system to execute actions. Commands may refer to asynchronous actions. Commands may represent intentions rather than facts, referring to instructions to execution actions, rather than recording the outcome of the execution. The GUI may indicate whether execution of the action was successful or not. The events may be associated from the outcome of the execution.

The GUI may further depict one or more of: an indication of a full state of the event-sourced system, one or more snapshots, and one or more data projections.

The full state may refer to the current, complete representation of the components and/or aggregates in the event-sourced system based on the history of events. This full state may be derived by replaying or applying each recorded event in the sequence the events occurred, building up the current state from an initial, empty state.

Snapshots may refer to periodic records of the full state of the event-sourced at a specific point in time. Each snapshot represents the full state of the event-sourced system at a specific historical time.

The GUI may further depict a reduction in the state to a specific event. Reducing the state to a specific event may refer to reconstructing the state of the event-sourced system as it was immediately after a particular event in the sequence, rather than its current state, by starting from the initial state and applying only the events up to and including that specific event.

The GUI may further depicting a hierarchy of a message. The hierarchy may include one or more parents of the message and/or one or more children of the message.

At 204, a selection for emulation is received via the GUI.

The selection for emulation may be of:
A message from the messages presented within the GUI.
A command from the commands presented within the GUI. The command may have been already executed (i.e., execution has complete). Alternatively, the command may be scheduled for execution, or in the process of being executed.
A new message not presented within the GUI, for example, manually entered by a user, and/or selected by a user from a list of predefined messages defined for the event-sourced system.
A command message not presented within the GUI, for example, manually entered by a user, and/or selected by a user from a list of predefined commands defined for the event-sourced system.

The selection of the message and/or command may be made, for example, by clicking on the message and/or command presented within the GUI, clicking a selection box in proximity to the message and/or command, verbally speaking in to a microphone and analysis by voice recognition software, and the like.

Optionally, an indication of the type of emulation is received via the GUI. For example, the user clicks a checkbox next to the type of emulation, the user click on the type of emulation from a list of types of emulation, and the like. Alternatively, the type of emulation may be pre-defined and/or automatically set based on the selection. For example, according to whether the selection is of a message or of a command, and/or according to whether an existing message/command is selected or whether a new message/command is selected. The type of emulation may include:
Re-running the selected message to the event-sourced system. When the selected message has already been run by the event-sourced system, re-running the selected message may be used to help trace and/or understand the impact of running the selected message on the event-sourced system.
Sending the new message to the event-sourced system. When the new message has not yet been run by the event-sourced system, running the new message by the event-sourced system may be used to predict impact of the new message on the event-sourced system.
Re-executing the selected command by the event-sourced system. When the selected command has already been executed by the event-sourced system, re-executing the selected message may be used to help trace and/or understand the impact of executed the selected command by the event-sourced system.
Executing the new command by the event-sourced system. When the new command has not yet been executed by the event-sourced system, executing the new command by the event-sourced system may be used to predict impact of the new command on the event-sourced system.

At 206, the emulation of execution of the selected message and/or command within the event-sourced system is implemented.

Optionally, when a state of the event-sourced system is defined as a deterministic outcome of all events, the emulation to obtain a current state of the event-sourced system may be performed by processing the events (e.g., manually or by producing another event). The events may be imported to another computing environment (e.g., a local development environment), which may be logically separated from the original computing environment of the event-sourced system, where the (exact) conditions from the original (e.g., production) environment of the event-sourced system are replicated. The selected message and/or command is executed within the other computing environment, without impacting the event-sourced system. Modifications to the logic affecting the current state of the event-sourced system may be examined in the other computing environment without impact the original environment, i.e., without impacting the event-sourced system. The examination may be done by the user via the GUI, as described herein.

Optionally, the emulation is implemented by accessing a historical snapshot of the event-sourced system prior to running the selected message and/or execution of the selected command. Starting from the historical snapshot, the selected message is sent to the event-sourced system, and/or the selected command is executed.

Alternatively, the emulation is implemented from the current state of the event-sourced system, by running the selected message and/or executing the selected command from the current state. The event-sourced system may be restored to the previously current state from the new state obtained from running the selected message and/or execution of the command. A prediction of the new state of the event-sourced system generated from running the selected message and/or execution of the command may be determined.

Emulation by re-running a command may be a mutating action. The re-running of the command may affect the state of the event-sourced system by producing a new event every time the command is run. Re-running the command may be used, for example, for debugging purposes, to examine how modifications to the command affect output in response to execution of the command. It is noted that re-running the command is different than re-trying the command. Re-trying the command may be an automatic (and optionally configurable) action that may or may not occur. It both cases the command runs multiple times, which is visible and traceable through the GUI.

At 208, the GUI is dynamically adapted and updated in response to the implementation of the emulation.

Optionally, each emulation of execution is documented and accessible (e.g., viewable, available for interaction) via the GUI.

The messages, the events, and/or the commands presented within the GUI are adapted to depict the change in state of the event-sourced system generated in response to the emulation.

Optionally, when a new message, a new event, and/or a new command, is generated in response to the emulation, the GUI is updated to present the new message, new event, and/or new command.

Alternatively or additionally, the GUI is updated to present an outcome of the emulation of execution of the selection (e.g., message and/or command) within the event-sourced system

Alternatively or additionally, when an existing message(s), an existing event(s), and/or an existing command(s) are adapted in response to the emulated execution, the GUI is updated to present the adapted message and/or adapted existing event and/or adapted existing command.

Alternatively or additionally, when a full state of the event-sourced system is predicted in response to the emulation, the GUI is updated to present the prediction of the full state within the GUI.

Alternatively or additionally, when a data projection(s) is predicted in response to the emulation, the GUI is updated to present the predicted data projection(s). The data projection(s) may be computed based on a prediction of the events and/or messages and/or commands that are generated as part of the emulation.

Alternatively or additionally, when a predicted snapshot indicating a predicted state of one or more components of the event-sourced system, in response to the emulation, is computed, the GUI is updated to present the predicted snapshot.

Optionally, adaptations of elements within the GUI are visually marked, for example, messages, events, commands, full state, data projection, snapshot, and hierarchy, are visually marked to indicate the adaptation. The visual marking of the adapted elements may aid the user in tracking changes to the elements that occurred in response to the GUI. Visual marking may be implemented as, for example, bolding, highlight using a distinct color, distinct color of font, italics, using a boundary box, using an arrow, and the like.

Optionally, one or more parameters are computed for the events and/or commands and/or messages, for example, reads, runtime, and size. The total number of reads, runtime, and/or size may be computed, and presented within the GUI. The parameters (e.g., total number of reads, runtime, and/or size) may be is computed for the updated events and/or commands and/or messages predicted in response to the emulation.

Adaptations of the messages, events, and/or commands, may be visually marked, such as new messages, new events, and/or new commands, which are newly generated due to the emulation. In another example, visual marking is performed for changes to existing messages, changes to existing events, and/or changes to existing commands, where the change occurs due to the selected emulation and may be different than changes occurring when no emulation is selected. In yet another example, visual marking is performed for non-presence of messages, events, and/or commands, which are not generated by the emulation, but would otherwise be generated. In yet another example, messages, events, and/or commands, which are predicted to be impacted by the emulation, are visually marked. These messages, events, and/or commands may be visually marked prior to execution of the emulation, to enable tracking their adaption that occurs after execution of the emulation. For example, a certain command whose execution is predicted to fail during emulation of generation of a certain message may be color coded. This may help indicate to the user which command failed to complete execution when the certain message has been generated, such as to help troubleshoot a problem.

Optionally, a failure and/or error in the event-sourced system may be generated during the emulation of execution. Failures and/or errors in the event-sourced system may be propagated in the GUI. The failures and/or errors may be triggered by the emulation of execution. The message and/or the command that triggered the failure and/or error may be presented within the GUI. The error and/or failure may be indicated, for example, visually marked (e.g., bolded, highlighted, arrow pointing to them). The errors may appear in in the GUI such as for helping to determine the cause of the error, for example, within a hierarchy presentation described herein.

At 210, one or more other inputs from a user are received via the GUI, and the GUI is updated accordingly. The input may be performed, for example, by a click of the user within the GUI on a data element, selection of a selection box, verbal selection made via speaking into a microphone and analysis by voice recognition software, and the like.

Optionally, the input received via the GUI includes a selection of a message and/or command and/or event for presentation of a hierarchy thereof. In response to the input, the GUI is updated to present the hierarchy of the selected message and/or command and/or event. The hierarchy may include ancestors and/or descendants. The number of presented generations of ancestors and/or descendants may be, for example, a single generation, two generations, predefined number, and/or selected by a user.

Optionally, the message and/or command and/or event selected for presentation of the hierarchy thereof may be the message and/or command and/or event selected for emulation. The GUI presents a predicted hierarchy of predicted ancestors and descendants, generated in response to the emulation. When the message and/or command and/or event selected for presentation of the hierarchy includes a new message and/or new command and/or new event predicted to be generated in response to the emulation, the GUI presents the hierarchy for the predicted new message and/or the predicted new command and/or the predicted new event. For example, a user uses the GUI to select a certain command, and runs an emulation using the certain command. Running the emulation results in generation of a new message. The hierarchy for the new message may be presented within the GUI. The ancestors of the new message depicted in the hierarchy may include the certain command used to trigger the emulation.

Examples of relationships depicted by the hierarchy include:
Producer messages generate events, in a one-to-one relationship.
Events may trigger commands. One event may trigger multiple commands.
Commands may produce events. Each command may produce multiple events.

Optionally, the input received via the GUI includes a selection of a message and/or command and/or event, for which a full state is to be predicted. The GUI presents the predicted full state. Optionally, the message and/or command and/or event for which the full state is to be predicted includes an adapted message and/or adapted command and/or adapted event (e.g., a new message and/or new command and/or new event), generated in response to the emulation. The predicted full state presented in the GUI represents the full state based on the adapted message and/or adapted command and/or adapted event.

At 212, one or more features described with reference to 204-210 may be dynamically iterated.

The iterations may be performed for dynamically changing states of the GUI. For example:
The iterations may be performed for toggling the GUI between a first state depicting the messages, events, and commands in response to the emulation, and a second state depicting the messages, events, and commands prior to the emulation. This may allow a user to understand the impact on the event-sourced system due to the emulation.
The iterations may be performed for incrementally performing emulations of the event-sourced system. For example, in a first iteration, a first emulation is performed, and a first state of the event-sourced system is obtained. In a second iteration, a second emulation is performed starting from the first state, to obtain a second state.
The iterations may be performed for incrementally observing changes in state of the event-sourced system, for example, iteratively presenting sequential snapshots of states.

Referring now back to FIG. 3, an exemplary GUI 302 for monitoring and/or managing and/or analyzing the event-sourced system is presented.

GUI 302 may present one or more of the following datasets: messages 304, events 306, and commands 308. The dataset may be presented, for example, within windows and/or as columns such as a list.

One or more of the following may be depicted in association with each message in window 304:
An indication of the message, such as a box, name of the message, and the like. Selection of the message (e.g., double clicking on the message) presents the contents of the message. The contents of the message may include metadata (e.g., timestamps, unique IDs, and versioning information) and/or core data indicating the event and/or command.
An interactive element that when selected (e.g., clicked) triggers the emulation, by resending and/or newly sending the message to the event-sourced system. The interactive element may be, for example, an arrow such as a dispatch arrow, an icon, a selection box, and the like.
Timestamp.
Type. There may be multiple message types, which may indicate different data inputs, such as different data producers (e.g., different components of the event-sourced system).

Messages 304 may be clustered into multiple clusters, for example, according to type. Messages of a certain cluster may be presented within the GUI in response to a selection, for example, clicking a tab corresponding to the certain cluster. Other clusters may not be presented when the certain cluster is presented.

One or more of the following may be depicted in association with each event in window 306:
An indication of the event, such as a box, name of the event, and the like. Selection of the event (e.g., double clicking on the event) presents the contents of the event.
Log of actions associated with the event.
State changes associated with the event.
Timestamp.
Type.
Size.

A summary of the events may be presented. The summary may include a total number of one or more of: reads, runtime, and size, of the events. The summary may facilitate performance analysis.

One or more of the following may be depicted in association with each command in window 308:
An indication of the command, such as a box, name of the command, and the like. Selection of the command (e.g., double clicking on the command) presents the contents of the command.
An interactive element that when selected (e.g., clicked) triggers the emulation, by newly executing and/or re-executing the command by the event-sourced system. The interactive element may be, for example, an arrow such as a dispatch arrow, an icon, a selection box, and the like.
Status indicator, for example, completed, and in-progress.
Timestamp

A summary of the commands may be presented. The summary may include a total number of one or more of: runtime, and size. The summary may aid in resource management.

Referring now back to FIG. 4, GUI 402 depicts additional exemplary features that may be presented. The features described with reference to GUI 402 may be simultaneously presented within GUI 302 of FIG. 3 with the features described with reference to GUI 302. Alternatively, a selection element may be designed to toggle between GUI 302 and GUI 402, for example, a tab, an icon, and the like.

GUI 402 may depict one or more of: an indication of a full state 404 of the event-sourced system, one or more snapshots 406, and one or more data projections 408. The snapshots and/or data projects may be presented, for example, within windows and/or as columns such as a list.

Full state 404 window captures a complete snapshot of the state of the event-sourced system at a current time and/or a specific time.

One or more of the following may be depicted in association with the full state in window 404:
Time of capture.
Type, for example, full state.
Number of events.
Total size.

Snapshot window 406 presents incremental states of the event-sourced system. The snapshots may be used for historical state analysis.

One or more of the following may be depicted in association with each snapshot in window 406:
Timestamp.
Type (e.g., snapshot).
Number of events.
Last event ID.
Size.

Data projections window 408 presents different data projections, which may provide multiple different perspectives on the data. Each data projection may represent a distinct view of the data.

One or more of the following may be depicted in association with each data projection in window 408:
Number of events.
Size.

Referring now back to FIG. 5, exemplary GUI 502 depict an interactive element 504 for reducing the state to a specific event. GUI 502 may be implemented within GUI 302. Interactive element 504 may be presented within GUI 302.

Referring now back to FIG. 6, exemplary GUI 602 depicts window 604 presenting a hierarchy for a selected message. The hierarchy may include one or more parents, and/or one or more children (i.e., ancestors).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant GUIs will be developed and the scope of the term GUI is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of processing data using at least one processor coupled to a memory, the method comprising:
displaying via a display device of a client computing device, an interactive graphical user interface (GUI) for monitoring and managing an event-sourced system;
presenting within the GUI:
a plurality of messages transmitted within the event-sourced system,
a plurality of events of the event-sourced system, and
a plurality of commands executed by the event-sourced system;
receiving, via the GUI, a selection for emulation of execution of at least one of: a message from the plurality of messages, and a command from the plurality of commands;
in response to the selection for emulation, computing an emulation of execution of the selected at least one of: the message and the command, within the event-sourced system; and
dynamically updating at least one of the plurality of messages, the plurality of events, and the plurality of commands, presented within the GUI, with an outcome of the emulation of execution of the selected at least one of: the message and the command, within the event-sourced system.

2. The computer implemented method of claim 1, wherein the emulation of execution of the selection is for re-running of a previously generated message and/or re-execution of a previously executed command, starting from a preceding snapshot of the event-sourced system prior to generation of the message and/or prior to execution of the command.

3. The computer implemented method of claim 1, wherein the emulation of execution of the selection is for a prediction of impact on the event-sourced system by generation of a new message and/or execution of a new command.

4. The computer implemented method of claim 1, further comprising toggling the GUI between a first state depicting the messages, events, and commands in response to the emulation, and a second state depicting the messages, events, and commands prior to the emulation.

5. The computer implemented method of claim 1, wherein the emulation is performed by importing the events to another computing environment separate from the event-sourced system where conditions of the event-sourced system are replicated, and executing the selected at least one of: the message and the command, within the another computing environment without impacting the event-sourced system.

6. The computer implemented method of claim 1, further comprising:
wherein in response to a failure and/or error in the event-sourced system generated during the emulation of execution,
presenting within the GUI, the message and/or the command that triggered the failure and/or error.

7. The computer implemented method of claim 1, wherein at least one of: a new message, a new event, and a new command, is generated in response to the emulated execution, wherein at least one of the plurality of messages, the plurality of events, and the plurality of commands, presented within the GUI, are updated to include the at least one of: the new message, the new event, and the new command.

8. The computer implemented method of claim 1, wherein at least one of: an existing message, an existing event, and an existing command, is adapted in response to the emulated execution, wherein at least one of the plurality of messages, the plurality of events, and the plurality of commands, presented within the GUI, are updated to depict the at least one of: the adapted message, the adapted event, and the adapted command.

9. The computer implemented method of claim 1, further comprising visually marking within the GUI at least one of the plurality of messages, the plurality of events, and the plurality of commands, predicted to be impacted by the emulation.

10. The computer implemented method of claim 1, further comprising:
predicting a full state of the event-sourced system in response to the emulation; and
wherein dynamically updating comprises presenting the prediction of the full state within the GUI.

11. The computer implemented method of claim 1, further comprising:
predicting at least one data projection in response to the emulation, wherein the at least one data projection is computed based on a prediction of the plurality of events in response to the emulation; and
wherein dynamically updating comprises presenting the prediction of the at least one data projection within the GUI.

12. The computer implemented method of claim 1, further comprising:
computing at least one predicted snapshot indicating a predicted state of at least one component of the event-sourced system, in response to the emulation; and
wherein dynamically updating comprises presenting the at least one predicted snapshot within the GUI.

13. The computer implemented method of claim 1, wherein the selection for emulation comprises a message selected from the plurality of messages presented within the GUI, and emulation comprises emulating re-sending of the message to the event-sourced system.

14. The computer implemented method of claim 1, wherein the selection for emulation comprises a command selected from the plurality of commands presented within the GUI, and emulation comprises emulating repeating execution of the command within the event-sourced system.

15. The computer implemented method of claim 1, wherein the selection for emulation comprises at least one of: a new message and a new command manually entered by a user and/or selected via the GUI from a predefined list, and emulation comprises predicting impact of at least one of: sending the at least one new message to the event-sourced system and execution of the new command by the event-sourced system.

16. The computer implemented method of claim 1, further comprising:
receiving a selection of at least one of: a message from the plurality of messages, and a command from the plurality of commands; and
presenting within the GUI, a hierarchy of the at least one of: the selected message, and the selected command, the hierarchy including ancestors and descendants.

17. The computer implemented method of claim 16, wherein the at least one of selected message and the selected command comprises the message and/or command selected for emulation, and wherein the hierarchy of the at least one of the selected message and the selected command includes a predicted hierarchy including predicted ancestors and descendants, generated in response to the emulation.

18. The computer implemented method of claim 16, wherein at least one of the selected message and the selected command comprises at least one of a new message and a new command predicted to be generated in response to the emulation, wherein the GUI presents the hierarchy for at least one of the predicted new message and the predicted new command.

19. The computer implemented method of claim 1, further comprising:
receiving, via the GUI, a selection of an event of the plurality of events;
predicting the full state according to the selected event; and
presenting the predicted full state within the GUI.

20. The computer implemented method of claim 19, wherein the selected event comprises a new event predicted to occur in response to the emulation.

21. The computer implemented method of claim 1, further comprising:
computing a total number of at least one of: reads, runtime, and size, of the plurality of events; and
presenting within the GUI, the total number of the at least one of: reads, runtime, and size.

22. The computer implemented method of claim 21, wherein the total number of at least one of: reads, runtime, and size, is computed for the updated plurality of events predicted in response to emulation.

23. A system for processing data using at least one processor coupled to a memory, comprising:
at least one processor executing a code for:
displaying via a display device of a client computing device, an interactive graphical user interface (GUI) for monitoring and managing an event-sourced system;
presenting within the GUI:
a plurality of messages transmitted within the event-sourced system,
a plurality of events of the event-sourced system, and
a plurality of commands executed by the event-sourced system;
receiving, via the GUI, a selection for emulation of execution of at least one of: a message from the plurality of messages, and a command from the plurality of commands;
in response to the selection for emulation, computing an emulation of execution of the selected at least one of: the message and the command, within the event-sourced system; and
dynamically updating at least one of the plurality of messages, the plurality of events, and the plurality of commands, presented within the GUI, with an outcome of the emulation of execution of the selected at least one of: the message and the command, within the event-sourced system.

24. A non-transitory medium storing program instructions for processing data using at least one processor coupled to a memory, comprising program instructions which when executed by the at least one processor, cause the at least one processor to:
display via a display device of a client computing device, an interactive graphical user interface (GUI) for monitoring and managing an event-sourced system;
present within the GUI:
a plurality of messages transmitted within the event-sourced system,
a plurality of events of the event-sourced system, and
a plurality of commands executed by the event-sourced system;
receive, via the GUI, a selection for emulation of execution of at least one of: a
message from the plurality of messages, and a command from the plurality of commands;
in response to the selection for emulation, compute an emulation of execution of the selected at least one of: the message and the command, within the event-sourced system; and
dynamically update at least one of the plurality of messages, the plurality of events, and the plurality of commands, presented within the GUI, with an outcome of the emulation of execution of the selected at least one of: the message and the command, within the event-sourced system.
